(19) United States
(12) Patent Application Publication
(10) Pub. No.: US 2021/0295355 A1
(43) Pub. Date: Sep. 23, 2021

(54) TECHNIQUES FOR GENERATING VALUES FOR INCOMPLETE PROFILE DATA

(71) Applicant: Visa International Service Association, San Francisco, CA (US)

(72) Inventors: James McDonald Bostock, Foster City, CA (US); Lisa Hammitt, Burlingame, CA (US)

(21) Appl. No.: 16/827,387

(22) Filed: Mar. 23, 2020

(51) Int. Cl. G06Q 30/02; G06Q 10/10; G06F 16/23; G06N 20/00

(52) U.S. Cl. CPC G06Q 30/0201; G06Q 30/0282; G06N 20/00; G06F 16/2379; G06Q 10/10

(57) ABSTRACT

Embodiments of the invention are directed to systems, methods, and devices for generating values for an incomplete profile. By way of example, an incomplete profile for an entity (e.g., a resource provider) associated with a review platform may be analyzed to identify missing/empty data fields. In some embodiments, the incomplete profile may include a plurality of data fields, wherein at least one data field of the profile is empty. The method may further include determining, by the server computer, at least one data element for the at least one data field using transaction data associated with at least one transaction. The unknown data field can be populated with the determined data element, thereby completing or partially completing the incomplete profile. These operations can be performed independent of user interaction.

### BACKGROUND

Resource providers (e.g., review platforms, social media providers, etc.) commonly require entities to perform a registration process in gain access to the resources provided. Conventionally, a user associated with the entity may be required to provide various profile data characterizing and/or describing the entity and/or characteristics of the entity. This process can be tedious and cumbersome for the user. Additionally, this profile data might change over time. Conventionally, these changes are captured by manual updates performed by the user which, again, may be tedious and cumbersome. These negative aspects of manual update may cause the profile data to be inaccurately represented by the resource provider.

Embodiments of this disclosure address these and other problems, individually and collectively.

### SUMMARY

One embodiment of the invention is directed to a method. The method may comprise analyzing, by server computer, an incomplete profile for an entity associated with a review platform. In some embodiments, the incomplete profile may include a plurality of data fields, wherein at least one data field in the plurality of data fields is empty. The method may further include determining, by the server computer, at least one data element for the at least one data field using transaction data associated with at least one transaction. The method may further include populating, by the server computer, the at least one data field, thereby completing or partially completing the incomplete profile.

In some embodiments, the incomplete profile is associated with a first resource provider identifier, and the method further comprises determining, by the server computer, a second resource provider identifier associated with the first resource provider identifier. The method may further comprise determining, by the server computer, a plurality of transaction messages associated with the second resource provider identifier, wherein determining the at least one data element include inferring the at least one data element from the plurality of transaction messages.

In some embodiments, the at least one data element comprises a time period when a resource provider associated with the first and second resource provider identifiers is publically operational. In some embodiments, the at least one data element comprises an indication that a resource provider accepts one or more forms of portable devices (e.g., debit cards, credit cards, devices operating a payment application, or the like).

In some embodiments, the method further comprises calculating, by the server computer, an average amount from amounts corresponding to the plurality of transaction messages. The method may further comprise determining, by the server computer, that the average amount exceeds one or more threshold amounts. In some embodiments, determining the at least one data element includes inferring the at least one data element based at least in part on determining that the average amount exceeds the one or more threshold amounts.

In some embodiments, determining the at least one data element includes inferring the at least one data element based at least in part on computing, by the server computer, a number associated with a subset of the plurality of transaction messages that exceed a predefined threshold value.

In some embodiments, determining the at least one data element includes inferring the at least one data element based at least in part on determining, by the server computer, a subset of transaction messages from the plurality of transaction messages. The subset of transaction messages may correspond to one or more transactions performed between the resource provider and a second entity. In some embodiments, the method may further comprise computing, by the server computer, a number of the subset of transaction messages. In some embodiments, determining the at least one data element includes inferring the at least one data element based at least in part on determining the number exceeds a predefined threshold.

In some embodiments, the method may further comprise receiving, by the server computer, the incomplete profile from a computing device associated with the review platform. The incomplete profile may be received based at least in part on execution of a registration process between the entity and the review platform.

In some embodiments, the method may further comprise periodically receiving, by the server computer from a computing device associated with the review platform, a data request for data associated with the entity. The incomplete profile may be analyzed in response to receiving the data request.

In some embodiments, the method may further comprise providing, by the server computer, the at least one data field to a computing device associated with the review platform. Providing the at least one data field to the computing device may cause the computing device to present the at least one data field at a user interface provided by the review platform.

Another embodiment may be directed to a server computer. The server computer may comprise one or more processors and one or more memories storing computer-executable instructions that, when executed by the one or more processors, cause the server computer to perform operations. The operations may include analyzing an incomplete profile for an entity associated with a review platform. In some embodiments, the incomplete profile may include a plurality of data fields and at least one data field in the plurality of data fields may be empty. The operations may further include determine at least one data element for the at least one data field using transaction data associated with at least one transaction. The operations may further include populating the at least one data field, thereby completing or partially completing the incomplete profile.

In some embodiments, executing the computer-executable instructions may further cause the server computer to maintain a mapping between the data fields corresponding to a particular review platform and a predetermined set of algorithms for calculating values for those data fields.

In some embodiments, executing the computer-executable instructions may further cause the server computer to maintain a machine-learning model trained to identify popularity scores for resource providers. In some embodiments, the machine-learning model may have been previously trained with at least one supervised learning technique and historical transaction data associated with popular and unpopular resource providers. Executing the computer-executable instructions may further cause causes the server computer to provide the transaction data to the machine-learning model as input and receive, from the machine-learning model, output indicating a popularity score for the resource provider. In some embodiments, determining the at least one data element includes inferring the at least one data element based at least in part on the popularity score for the resource provider.

In some embodiments, executing the computer-executable instructions may further cause causes the server computer to maintain a machine-learning model trained to identify characteristics of resource providers. In some embodiments, the machine-learning model may have been previously trained with at least one supervised learning technique and historical transaction data associated with resource providers having characteristics. Executing the computer-executable instructions may further cause causes the server computer to provide the transaction data to the machine-learning model as input and receive, from the machine-learning model, output indicating a particular characteristic for the resource provider. In some embodiments, determining the at least one data element includes inferring the at least one data element based at least in part on the particular characteristic.

In some embodiments, executing the computer-executable instructions may further cause causes the server computer to provide the at least one data field to the review platform. The review platform may provide the at least one data field via a user interface in response to receiving the at least one data field. The server computer may further be caused to receive, from the review platform, a confirmation indication indicating an accuracy of the at least one data field has been confirmed and update a training data set for the machine-learning model based at least in part on the confirmation indication.

In some embodiments, executing the computer-executable instructions may further cause causes the server computer to retrain or update the machine-learning model based at least in part on the training data set as updated.

In some embodiments, executing the computer-executable instructions may further cause causes the server computer to perform a registration process with the review platform. In some embodiments, at least part of the registration process includes identifying a mapping between a first set of data fields of the entity and either i) a set of algorithms used to compute corresponding values, or ii) a second set of data fields utilized by the server computer.

In some embodiments, executing the computer-executable instructions may further cause causes the server computer to maintain a plurality of mappings for a plurality of entities comprising the entity.

In some embodiments, the incomplete profile comprises a resource provider identifier and the transaction data may be retrievable based at least in part on the resource provider identifier. In some embodiments, the at least one data element corresponds to a characteristic of the entity.

Further details regarding embodiments of the invention can be found in the Detailed Description and the Figures.

### BRIEF DESCRIPTION OF THE DRAWINGS

FIG. 1 shows a block diagram of a system for generating profile data from transaction data, according to some embodiments.

FIG. 2 shows a flow of an example process for generating profile data from transaction data, according to some embodiments.

FIG. 3 shows a flow of another example process for generating profile data from transaction data, according to some embodiments.

FIG. 4 shows a block diagram of an exemplary data management computer, according to some embodiments.

FIG. 5 shows a block diagram of an exemplary review platform computer, according to some embodiments.

### DETAILED DESCRIPTION

Embodiments of the present invention are directed to generating values for incomplete profile data. In some embodiments, generating these values may include inferring data from transaction data. Although examples herein are directed to situations in which profile data for a review platform is generated, it should be appreciated that the techniques described herein may be utilized similarly in other contexts.

Prior to discussing specific embodiments of the invention, some terms may be described in detail.

The term “computing device” generally refers to a device that performs computations. A computing device may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. A “user device” is an example of a computing device. Examples of user devices include mobile phones (e.g. cellular phones), PDAs, tablet computers, net books, laptop computers, personal music players, hand-held specialized readers, etc. Further examples of user devices include wearable devices, such as smart watches, fitness bands, ankle bracelets, rings, earrings, etc., as well as automobiles with remote communication capabilities. A user device may comprise any suitable hardware and software for performing such functions, and may also include multiple devices or components (e.g. when a device has remote access to a network by tethering to another device—i.e. using the other device as a modem—both devices taken together may be considered a single user device).

A “user device” may comprise any suitable device that may be carried and/or operated by a user. Examples of portable devices may include mobile communication devices (e.g., mobile phones), payment devices (e.g., credit cards, debit cards, etc.), etc. A user device can store sensitive information such as payment credentials (e.g., primary account numbers, tokens, expiration dates, etc.).

An “entity” may include an individual, a company, a restaurant, a merchant, a financial institution, a research organization, a medical organization, or the like.

A “characteristic” refers to any suitable attribute that describes an entity. Examples of characteristics of an entity may include an entity type (e.g., restaurant, doctor's office, hospital, coffee shop, clothing store, etc.).

A “review platform” may be a forum that enables individuals to provide reviews for one or more entities. By way of example, a user could add a review for a restaurant or doctor's office (or another suitable resource provider).

A “review platform computer” may include one or more computing devices. In some embodiments, the review platform computer can be a large mainframe, a minicomputer cluster, or a group of server computers functioning as a unit. The review platform computer may be coupled to one or more databases and may include any hardware, software, other logic, or combination of the preceding, for servicing requests from one or more client computers. The review platform computer may comprise one or more computational apparatuses and may use any of a variety of computing structures, arrangements, and compilations for servicing the requests from one or more client computers/applications.

A “profile” may include any suitable number of data fields (e.g., profile data) associated with a specific entity. By way of example, a resource provider (e.g., a restaurant) may be associated with a profile that includes data fields that indicate hours of operation (e.g., hours for which the provider is publically operations/open to the public), an average price for a meal, payment methods accepted, busiest times, whether the restaurant is popular (e.g., overall or for a specific population of people), a category (e.g., dine-in, takeout), and the like. A profile may include a particular number/set of data fields. Thus, an “incomplete profile” may refer to a profile for which at least one data field is empty (e.g., has not been assigned a value). A “data element” of a data field is intended to refer to a value of the data field.

A “data field” refers to any suitable data structure configured to store a piece of data. An “empty data field” refers to a data field for which a value has not be set/assigned. A “data element” refers to any suitable value of a corresponding data field.

A “time period” refers to a range of time associated with a start time and an end time.

A “resource provider identifier” is any suitable alphanumeric value, of any suitable form or length, that uniquely identifies a resource provider.

A “machine-learning algorithm” may be utilized to build a mathematical model based on sample data, known as “training data,” in order to make predictions or decisions without being explicitly programmed to perform the task. Some machine-learning algorithms include supervised learning algorithms (e.g., classification algorithms, regression algorithms, decision trees, random forest, etc. which utilize labeled training data), semi-supervised learning algorithms (e.g., algorithms which utilize training data in which some training examples are labeled and some are not), unsupervised learning algorithms (e.g., cluster analysis algorithms, k-nearest neighbor, Apriori, etc.), reinforced learning algorithms (e.g., Markov decision processes, etc.).

A “machine-learning model” may be a mathematical representation of a real-world process. In some embodiments, a machine-learning model may be a mathematical model that is generated and/or trained utilizing training data and a machine-learning algorithm. Some example models include, artificial neural networks, recurrent neural networks, decision trees, Bayesian networks,

An “application programming interface” (API) may be an interface or communication protocol between a client and a server. In some embodiments, an application programming interface may define formats for specific requests and corresponding responses. An API can take many forms, but can often include specifications for routines, data structures, object classes, variable, or remote calls. An API may be for a web-based system, an operating system, a database system, computer hardware, or a software library, to name a few.

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CW and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

A “resource provider” may be an entity that can provide a resource such as goods, services, information, and/or access. Examples of a resource provider includes merchants, access devices, secure data access points, etc. A “merchant” may typically be an entity that engages in transactions and can sell goods or services, or provide access to goods or services. A resource provider may operate a computer to perform operations, which can also be generically referred to as a “resource provider computer.” The term “resource provider computer” can be used to refer to one or more resource provider computers.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”. The term “transport provider computer” can be used to refer to one or more transport computers.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer. An authorizing entity may operate a computer to perform operations, which can also be generically referred to as an “authorizing entity computer”.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable device (e.g., a payment device and/or mobile device). In some embodiments, a cellular phone, tablet, or other dedicated wireless device used as a POS terminal may be referred to as a mobile point of sale or an “mPOS” terminal.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “transaction data” including, by way of example only: a service code, a CVV (card verification value), a dCW (dynamic card verification value), a PAN (primary account number or “account number”), a payment token, a user name, an expiration date, etc. The authorization request message may include additional “transaction data,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to the merchant.

A “transaction message” may refer to any suitable message related to a transaction between two entities. In some embodiments, a transaction message may refer to any suitable combination of an authorization request message and a corresponding authorization response message. “Transaction data” can therefore refer to any suitable data obtainable from an authorization request message and/or a corresponding authorization response message.

A “data request” may be any suitable message of any suitable format that requests data. By way of example, a data request may be a message (also referred to as a data request message) that requests profile data for a given entity. In some embodiments, a “data response” may be any suitable message of any suitable format that is utilized to respond to a data request.

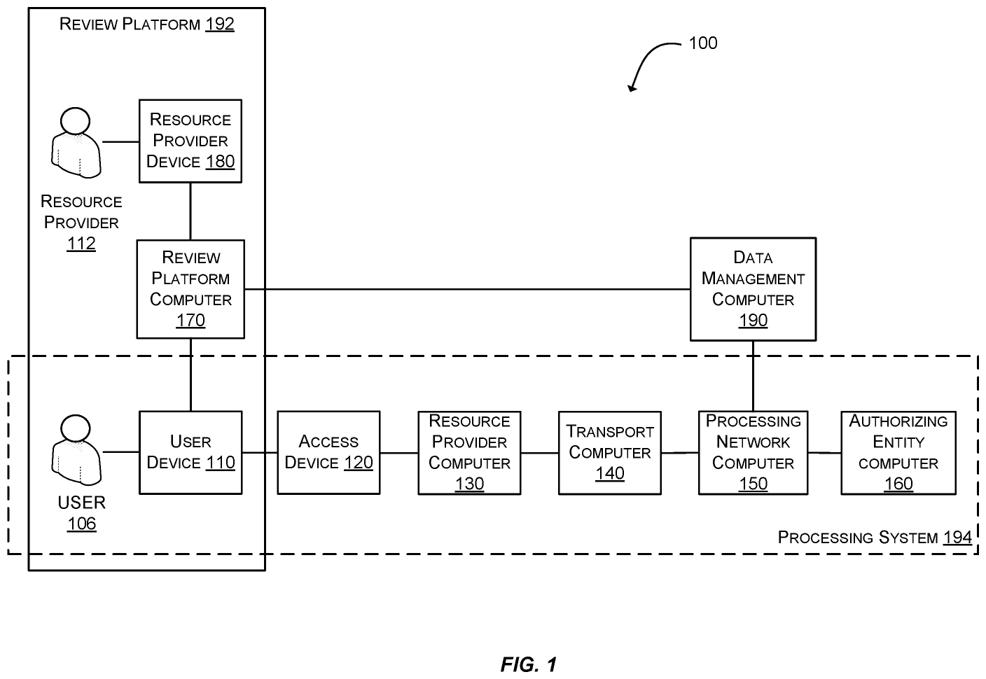

FIG. 1 shows a block diagram of a system 100 for generating values for incomplete profile data using transaction data. FIG. 1 shows a user 106 that can operate a user device 110 (e.g., a debit card, a credit card, a computing device configured with payment credentials, etc.). The user 106 may use the user device 110 to pay for a good or service (e.g., a meal), at a resource provider location (e.g., a location associated with the resource provider 112). The resource provider (e.g., resource provider 112) may include any suitable entity (e.g., a restaurant). In some embodiments, the user device 110 is a credit card or debit card issued by the authorizing entity. The resource provider 112 operate a resource provider computer 130 and/or an access device 120. The resource provider computer 130 may be configured to communicate with an authorizing entity computer 160 operated by, or on behalf of, an authorizing entity, via a transport computer 140 (operated by an acquirer) and a processing network computer 150 operating as part of a payment processing network.

The payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A typical payment transaction can be described as follows, the user 106 will insert the user device 110 (e.g., a debit card, a credit card, etc.) into an interface of the access device 120 (e.g., a card reader located at a restaurant associated with the resource provider 112). In some embodiments, the user device 110 may be held near the access device 120. The access device 120 may request payment credentials from the user device 110 and transmit said payment credentials to the resource provider computer 930.

The resource provider computer 130 may then generate an authorization request message that includes at least a portion of the information received from the access device 120 and electronically transmits this message to a transport computer 140.

In some embodiments, the authorization request message may be forwarded to the authorizing entity computer 160 for further processing by the transport computer 140 via the processing network computer 150. In some embodiments, prior to the occurrence of a credit or debit-card transaction, the processing network computer 150 has an established protocol with each issuer on how the issuer's transactions are to be authorized. In some cases, such as when the transaction amount is below a threshold value, the processing network computer 150 may be configured to authorize the transaction based on information that it has about the user's account without generating and transmitting an authorization request message to the authorizing entity computer 160. In other cases, such as when the transaction amount is above a threshold value, the processing network computer 150 may receive the authorization request message, determine the issuer associated with the user device 110, and forward the authorization request message for the transaction to the authorizing entity computer 160 for verification and authorization. Once the transaction is authorized, the authorizing entity computer 160 may generate an authorization response message (that may include an authorization code indicating the transaction is approved or declined) and transmit this electronic message (e.g., via an external communication interface) to processing network computer 150. The processing network computer 150 may then forward the authorization response message to the transport computer 140, which in turn may then transmit the electronic message to comprising the authorization indication to the resource provider computer 130, and then to the access device 120. In some embodiments, the authorization indication may be displayed at the user device 110.

At the end of the day or at some other suitable time interval, a clearing and settlement process between the resource provider computer 130, the transport computer 140, the processing network computer 150, and/or the authorizing entity computer 160 may be performed on the transaction.

In some embodiments, any suitable number of the components of FIG. 1 may be configured to communicate with review platform computer 170. Review platform computer 170 may include one or more computers configured to host and/or implement the review platform 192. The review platform computer 170 may be configured to provide one or more user interfaces with profile data (e.g., one or more attributes and/or characteristics) of an entity (e.g., resource provider 112) may be presented. In some embodiments, the review platform computer 170 may be configured to provider one or more application programming interfaces with which the one or more user interfaces and/or one or more profiles may be updated.

In some embodiments, the review platform computer 170 may provide one or more user interfaces that are accessible (e.g., via a public network such as the Internet, not depicted) by the user device 110 (or another suitable user device such as a smartphone, a laptop, a desktop computer and the like). It should be appreciated that in some examples, the user 106 may utilize a first user device such as a debit card to initiate a transaction (e.g., purchasing a meal at restaurant A) and the user 106 may utilize a second user device to access the interface(s) provided by the review platform computer 170. For simplicity, the user device 110 may refer to one or both of these devices. In some embodiments, the resource provider 112 may utilize resource provider device 180 to access the review platform computer 170. The resource provider device 180 may be any suitable computing device (e.g., a computing device associated with a resource provider, another resource provider computer, etc.). The resources provider device 180 may be the same or a different device than the resource provider computer 130.

Both the resource provider device 180 and the user device 110 may be utilized to execute registration processes for the resource provider 112 and the user 106, respectively. By way of example, during a registration process, the resource provider 112 may utilize the resource provider device 180 to provide profile data (e.g., a name (“Restaurant A”), a location (“1234 Maple Drive, Seattle, Wash. 12421”), a phone number (“206-123-4567”), etc.) or any suitable portion of profile data. As a non-limiting example, the review platform computer 170 may maintain profile data for a variety of entities. A profile may include a predetermined set of data fields. “Profile data” may refer to any suitable combination of the data fields of a profile. These data fields may be the same across all types of entities or the particular set of data fields used for a particular entity may differ. By way of example, the set of data fields utilized for a restaurant may differ from the set of data fields utilized for a doctor's clinic. In some embodiments, the resource provider 112 may fail to provide a value (also referred to as a “data element”) for each and every data field of a profile. Such a profile, or profile data, can be referred to as an “incomplete profile” and/or “incomplete profile data.”

In some embodiments, any suitable number of the components of FIG. 1 may be configured to communicate with a data management computer 190. A data management computer may include one or more computers that provide one or more operations related to data management and/or augmentation. By way of example, the data management computer may be configured to store, access, or otherwise obtain any suitable number of transaction data (e.g., transaction messages including authorization request messages and/or corresponding authorization response messages) corresponding to one or more transactions processed by the processing network computer 150. The transaction data may include any suitable data obtained from an authorization request message, an authorization response message, and/or any suitable information known about one or more parties of the transaction.

In some embodiments, the data management computer 190 may be configured to generate values for empty profile data of the review platform 192 based at least in part on the transaction data obtained from the processing system 194. The data management computer 190 may process any suitable number of transaction messages (e.g., authorization request messages and/or authorization response messages) associated with any suitable number of entities (e.g., account holders and/or resource providers) according to a predetermined frequency, on demand, or at any suitable time. In some embodiments, the data management computer 190 may provide one or more application programming interfaces through which some portion of its functionality may be invoked. By way of example, the data management computer 190 may provide one or more application programming interfaces through which a data request may be transmitted from the review platform computer 170 to the data management computer 190.

In some embodiments, the data request may include any suitable portion of profile data know by the review platform computer 170 and associated with a given entity (e.g., the resource provider 112). By way of example, the data request may include, but is not limited to, a resource provider identifier (e.g., a first resource provider identifier) of the resource provider 112 within the review platform 192 and a resource provider identifier (e.g., a second resource provider identifier) of the resource provider 112 within the processing system 194. The data management computer 190 may maintain any suitable data/mapping that identifies data fields and/or corresponding algorithms and/or computations for computing values for those data fields. These mappings may further identify a particular set of transaction to be utilized to perform the computation (e.g., transaction data of a particular entity or multiple entities over a given time period such as the last week, last month, last year, etc.). The data management computer 190 may maintain any suitable number of mappings corresponding to any suitable number of entities for which it is configured to support. In some embodiments, the data management computer 190 may train, maintain, and/or access one or more machine learning models that have been trained (e.g., based on historical transaction data (past authorization request messages and/or past authorization response messages) of one or more users) to identify values for one or more of those data fields. Using previous transaction data associated with the user 106 and/or one or more other users of the processing system 194, the data management computer 190 may infer values (also referred to as “data elements”) for any suitable number of data fields corresponding to the data request.

As an example, the resource provider 112 may fail to provide hours (and/or days) of operation for his restaurant (e.g., days and times during which the restaurant is publically operational/open to the public) to the review platform computer 170. A data request may be transmitted from the review platform computer 170 to the data management computer 190. In response to the data request, the data management computer 190 can analyze the transaction data (e.g., any suitable number of transactions performed at the resource provider's location) to infer the values for the hours (and/or days) of operation. The transaction data can include any suitable number of authorization request messages and/or corresponding authorization response messages related to those transaction performed at the resource provider's location. The data management computer 190 can analyze the transaction data to identify that transactions were conducted between the hours of 9 AM and 5 PM, on weekdays, and 10 AM-8 PM on Sundays and Saturdays. In some embodiments, the data management computer 190 may be configured to round up or down (e.g., to the nearest quarter of an hour, half of an hour, hour, etc.) when analyzing the transaction data. For example, an earliest transaction of a Tuesday may have occurred at 9:02 AM. The data management computer 190 may be configured determine a start time for Tuesdays of 9:00 AM based at least in part on rounding 9:02 AM down to the nearest (previous) quarter of an hour. Similarly, a latest transaction for a Tuesday may have occurred at 4:49 PM. Thus, the data management computer 190 may be configured to determine an end time for Tuesday of 5:00 PM based at least in part on rounding 4:49 PM up to the nearest quarter hour. In response to identifying hours and/or days during which transaction were conducted, the data management computer 190 can transmit a data response message corresponding to the data request to the review platform computer 170 with the hours/days of operation for the resource provider 112. In some embodiments, the review platform computer 170 can be configured to update one or more data fields of the profile of the resource provider 112 to include that data. In some embodiments, updating the profile data of the resource provider 112 may cause the review platform computer 170 to present the one or more data fields of the updated profile via any suitable interface. Thus, in some embodiments, the user 106 may then view the hours and/or days of operations associated with the resource provider 112, despite the fact the resource provider 112 did not manually provide such information. Over time, if the hours and/or days of operations change, the resource provider 112 may be saved the time and hassle of updating this information. Rather, the data management computer 190 can be configured to monitor and/or periodically reanalyze recent transaction data (e.g., transaction data over the last month, year, 6 months, etc.) and can automatically update the hours and/or days of operation without user interaction. In some embodiments, the resource provider 112 may be prompted to approve such operations prior to any update to its profile data.

In some embodiments, the data management computer 190 may further be configured to infer data on behalf of the user 106 based on previous transaction data associated with the user 106. As a non-limiting example, the data management computer 190 may store a mapping that indicates data fields that may be provided as input by the user 106 to the review platform 192. By way of example, the user 106 may have the ability to provide a review of the resource provider 112 via the review platform 192. In some embodiments, the review can include a score based on a predetermined scale (e.g., a five star system in which one star is the worst rating available and five stars is the best rating available). In response to the user 106 selecting an option to add a review for the resource provider 112, the review platform computer 170 may transmit a data request for any suitable data corresponding to the user 106 and the resource provider 112. In some embodiments, the data management computer 190 may infer data such as a review score for the user 106 based at least in part on the transaction data associated with the user. For example, the user 106 may have transacted with the resource provider 112 ten times indicating the user 106 has frequented the restaurant of the resource provider 112 ten times. The data management computer 190 may be configured to identify, based on any suitable number of factors, a review score to be suggested to the user 106. For example, the data management computer 190 may assess how often the user frequents the restaurant, the price of the transaction, the average price of all transactions between the user 106 and the resource provider 112, whether the frequency of visits has increased/decreased over time, etc. The data management computer 190 may employ a set of rules to identify a particular review rating to suggest to the user. The more often the user frequents the restaurant, the higher the price of his meal(s), when his visits have increased over time, the higher the suggested review rating determined by the data management computer 190. The data management computer 190 may transmit the suggested review rating back to the review platform computer 170 to be displayed at the user device 110 via an interface of the review platform 192 (e.g., an interface provided by the review platform computer 170).

In some embodiments, the data management computer 190 may identify that a predetermined threshold condition has been met such as the user 106 has visited the restaurant over a threshold number of times. In some embodiments, the data management computer 190 may be configured to generate a suggested review rating based on determining that the threshold condition has been met rather than receiving a data request from the review platform computer 170.

It should be appreciated that the data management computer 190, although depicted as a separate computer, can be provided as part of the processing network computer 150 and/or the review platform computer 170.

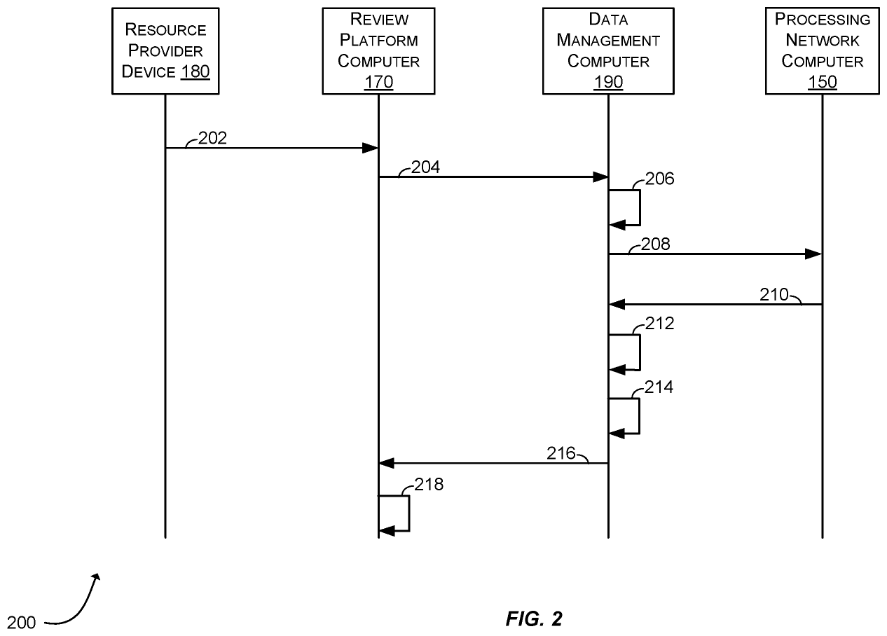

FIG. 2 shows a flow of an example method 200 for generating profile data from transaction data, according to some embodiments. It should be appreciated that the operations of the method 200 may be performed in any suitable, not necessarily the order depicted in FIG. 2. Further, the method 200 may include additional, or fewer operations than those depicted in FIG. 2. The operations of method 200 may be performed any suitable combination of one or more devices of FIG. 1.

The method 200 may begin at 202, where the resource provider device 180 may perform a registration process with the review platform computer 170. As a non-limiting example, the user (e.g., the resource provider 112 of FIG. 1) may utilize any suitable user interface provided by the review platform computer 170 (or any suitable computing component of the review platform 192 of FIG. 1) to perform said registration process. In some embodiments, as part of the registration process performed at 202, the user may enter in any suitable profile data. By way of example, profile data may include various data fields, including but not limited to, a name, an address, one or more phone numbers, one or more email addresses, one or more resource provider identifiers. The one or more resource provider identifiers may include a resource provider identifier for a resource provider 112 within the review platform 192 (referred to as “a first resource provider identifier”) and a resource provider identifier for the resource provider 112 within the processing system 194 (referred to as “a second resource provider identifier”), days of operation, one or more time periods (e.g., a time range for one or more days that indicates house the resource provider is publicly operational), an indication of what types of user devices the resource provider allows for transaction initiation (e.g., payment types accepted), one or more review ratings (e.g., an overall rating, a rating associated with a particular subset of the general population, etc.), an expense rating (e.g., cheap, average, expensive, etc.), traffic data indicating how busy the location is during particular days/times, nearby entities (e.g., other businesses, other restaurants, etc.), group rating(s) (e.g., indicating the entity serves many groups, is good for small groups, is good for large groups, is good for banquets, is good for groups over a particular number of people, etc.), an entity category (e.g., restaurant, doctor's clinic, dry cleaning provider, etc.), or any suitable characteristic or attribute of an entity. It should be appreciated that this set of data fields are used for illustration only and that the particular set of data fields utilized as profile data for an entity may differ. In some embodiments, the particular set of data fields may differ depending on the type of entity (e.g., restaurant versus car wash).

The user (e.g., resource provider 112) may utilize resource provider device 180 to enter any suitable combination of profile data utilizing the user interface(s) provided by the review platform computer 170. In at least one embodiment, after registration, the profile data may include at least one data field for which a value was not assigned and/or selected by the user. This data field may be referred to as being “empty.” As part of the registration process, the review platform computer 170 may be configured to assign a unique resource provider identifier (e.g., a first resource provider identifier) to the resource provider 112. In some embodiments, the review platform computer 170 may store the profile data as being associated with the resource provider identifier. In some embodiments, the profile data provided by the resource provider 112 may include a resource provider identifier (e.g., a second resource provider identifier such as a debit card number, an account number, a credit card number, etc.) that identifies the resource provider 112 within the processing system 194. Thus, the stored profile data may be considered a mapping between a resource provider identifier (e.g., the first resource provider identifier) of the review platform 192 and a resource provider identifier (e.g., a second resource provider identifier) of the processing system 194, or a separate mapping may be maintained that retains such data.

At 204, the review platform computer 170 may be configured to transmit a data request to the data management computer 190. The data request may be transmitted in response to completion of the registration process performed at 202 or the data request may be transmitted according to a schedule, at a predetermined periodic rate, upon manual request by the user (e.g., the resource provider 112 of FIG. 1), at any suitable time, or in response to any suitable stimuli. By way of example, the data request may be transmitted based at least in part on determining the registration process performed at 202 has completed. The data request may include an incomplete profile (e.g., a set of profile data for which one or more data fields are empty/null/not assigned) and/or the data request may include any suitable data. For example, the data request may include one or more resource provider identifiers (e.g., for the resource provider 112). In some embodiments, the data management computer 190 may store a profile template for the resource provider (e.g., an object, a list, or other container indicating the set of data fields of a profile associated with that resource provider and/or resource providers of the same type as the resource provider for which the data request is provided). In some embodiments, the data management computer 190 may store any suitable number of profile templates corresponding to any suitable number of resource providers and/or types of resource providers. If the data request includes data fields that are already known to the review platform computer 170, the data management computer 190 may analyze the profile to identify the manner in which the profile is incomplete (e.g., the particular set of data fields currently empty/unknown) based on comparing the data fields provided in the data request to the profile template associated with the resource provider. In some embodiments, the data management computer 190 may analyze the incomplete profile (e.g., identify missing and/or empty data fields) for an entity (e.g., the resource provider) associated with a review platform (e.g., the review platform 192) to identify which particular data elements (e.g., value(s) corresponding to particular data fields) are to be generated.

As a non-limiting example, the data request may include a resource provider identifier (e.g., a first resource provider identifier such as an alphanumeric value of any suitable length) with which the resource provider 112 is uniquely identifiable within the review platform 192, and a resource provider identifier (e.g., a second resource provider identifier such as an alphanumeric value of any suitable length) with which the resource provider 112 is uniquely identifiable within the processing system 194. In some embodiments, the resource provider identifier of the processing system 194 (e.g., the first resource provider identifier) may be an account number and/or a debit/credit card number associated with the resource provider 112. The data request may indicate one or more data fields for which a value is requested. In some embodiments, the data request (e.g., via having no additional data fields included other than the first resource identifier and the second resource identifier) may indicate a request for any data derivable by the data management computer 190. In some embodiments, profile data stored by the resource provider device 180 may be included in the data request to indicate what data has already been provided and/or what data fields are currently empty. The data management computer 190 may be configured to compare the data fields provided in the data request to a template associated with the resource provider 112 to identify which data fields are missing and/or empty. In some embodiments, the data request itself can indicate which data fields are provided and which data fields are missing (e.g., utilizing a particular value to indicate missing data and/or empty data).

At 206, the data management computer 190 may be configured to identify, from a mapping or rule set, a set of algorithms (e.g., one or more algorithms) and/or a set of one or more rules with which particular data field values (also referred to as “data elements”) are to be derived (generated). In some embodiments, the mapping or rule set may specify an amount and/or type of transaction data (e.g., one or more authorization request messages and/or one or more corresponding authorization response messages, authorization request and/or response messages associated with a single user or many users) to be utilized for each data field. In some embodiments, the mapping may indicate that the transaction data utilized for computing a data field value is to be associated with the entity specifically (e.g., transaction data associated with the resource provider 112) and/or the mapping may indicate that the transaction data utilized is to be associated with more than one entity (e.g., all transaction data for resource providers of a particular type such as all restaurants, all Italian restaurants if the resource provider associated with the data request is an Italian restaurant, etc.). In some embodiments, the mapping is retrievable from a set of mappings based at least in part on the first resource provider identifier.

At 208, the data management computer 190 may request the identified transaction data from the processing network computer 150. In some embodiments, the data management computer 190 need not request such data. Rather, the processing network computer 150 could be configured to transmit transaction data to the data management computer 190 according to a scheduled, predefined periodicity/frequency, or the like. In some embodiments, rather than requesting the identified transaction data from the processing network computer 150, the data management computer 190 may access a storage location from which the identified transaction data may be retrieved (not depicted). In some embodiments, the transaction data is retrievable from a set of transaction data (e.g., stored at the data management computer 190, at the processing network computer 150, and/or another storage location) based at least in part on using and/or providing the second resource provider identifier.

At 210, in response to receiving the request for transaction data, the processing network computer 150 may transmit the requested transaction data to the data management computer 190. As discussed above, the data management computer 190 may alternatively access and/or otherwise obtain the transaction data from any suitable storage location and/or the data management computer 190 may receive the transaction data from the processing network computer 150 according to a schedule or predetermined frequency.

At 212, the data management computer 190 may be configured to store the data fields received at 204 and the transaction data obtained at 210 as being associated with the resource provider for which the data request received at 204 pertains. By way of example, the data management computer 190 may store the incomplete profile (e.g., a set of data fields provided in the data request, a set of missing/empty data fields) in any suitable storage location for subsequent use. In some embodiments, the incomplete profile may be an object and/or other suitable contained configured to store the data fields. In some embodiments, the incomplete profile may be associated with the mapping identified for the data request.

At 214, the data management computer 190 may be configured to generate, derive, and/or infer one or more data field elements (e.g., values) for the empty data field(s) of the incomplete profile. For example, the data management computer 190 may determine (e.g., from a mapping) that a value for a data field “hours of operation” is to be derived, generated, and/or inferred from transaction data associated with the resource provider 112 (e.g., transactions conducted with the resource provider) over a particular time period (e.g., the last month). In some embodiments, an algorithm may be mapped to the particular data field (e.g., hours of operation) that indicates that an earliest transaction time and a latest transaction time are to be identified for each day of the week. In the example provided, if earliest transaction times are determined for four Mondays, the data management computer 190 may identify the earliest transaction time between those four Mondays and may set a lower time range value to that identified time. Similarly, the data management computer 190 may identify latest transaction times for each day of the week. If multiple transaction times are determined (e.g., a latest transaction time for each Monday of the last month), a latest time of those transaction times may be identified and set as the latest transaction time for that weekday. In some embodiments, the data management computer 190 may be configured to round the earliest/latest time up or down (e.g., the nearest hour, nearest half hour, nearest quarter hour, etc.).

For at least one data field, a corresponding algorithm (e.g., as determined from the mapping) may utilize a particular set of transaction data (e.g., transaction data including authorization request messages of the resource provider from the last month, year, week, etc.) to determine different types of user devices (e.g., VISA® cards, Mastercard®, Paypal®, ApplePay®, etc.) that were used to initiate that set of transaction data. In some embodiments, at least one data element of the profile may be used to store an indication that the resource provider allows these types of user devices to initiate transactions. In some embodiments, this information may be displayed to a user (e.g., user 106 of FIG. 1) as payments types accepted by the resource provider.

For at least one data field, a corresponding algorithm (e.g., as determined from the mapping) may utilize a particular set of transaction data (e.g., transaction data of the resource provider from the last month, year, week, etc.) to infer a data field element based on an average amount calculated from the set). By way of example, the algorithm may be utilized to assign an expense rating (e.g., cheap, average, expensive) based at least in part on determining that the average amount falls between a predetermined range and/or is less than or greater than a predefined threshold value (e.g., a predefined threshold amount). For example, a data field corresponding to an expense rating may be set to “$” (e.g., indicating a relatively inexpensive resource provider) when the average amount is determined to be between $1.00 and $20.00, “$$” (e.g., indicating a relatively averagely expensive resource provider) when the average amount is determined to be between $20.01 and $50.00, or “$$$” (e.g., indicating a relatively expensive resource provider) when the average amount is greater than a threshold value (e.g., $50.01). The ranges, thresholds and particular data elements (e.g., “$,” “$$,” “$$$”) used in this example are used for illustrative purposes only. Other values may be similarly utilized.

In some embodiments, an expense rating (or the ranges defining an expense rating) may be identified based at least in part on a machine learning model. The data management computer 190 may be configured to train and maintain (or access) a machine learning model that has been previously trained to identify an expense rating based on a set of transaction data provided as input. By way of example, the machine learning model may be trained using a training data set (e.g., historical transaction data) that includes various example transaction sets corresponding to individual resource provider for which an expense rating is known. Executing a supervised machine learning algorithm with the training data set may train the machine learning model (e.g., fit a mathematical model to the training data) such that new transaction data (e.g., this resource provider's last month of transaction data) may be provided to the model and the model may identify a new expense rating for the resource provider.

For at least one data field, a corresponding algorithm (e.g., as determined from the mapping) may utilize a particular portion (e.g., set/subset) of transaction data (e.g., transaction data from the last month, year, week, etc.) to determine a group rating (e.g., good for small groups, good for large groups, good for banquets, etc.). The algorithm may be utilized to determine a distribution of amounts from the transaction amounts of each of the transactions from the set/subset. The algorithm may be utilized to identify whether the entity is a good choice for a particular type of group (e.g., good for groups under 10 people). By way of example, the algorithm may utilize predetermined amounts, thresholds, and/or ranges to identify when a transaction likely includes a small group (e.g., under 5 people, etc.), a medium group (e.g., 6-10 people, etc.), a large group (e.g., 10-20 people, etc.), a banquet (e.g., greater than 20 people, etc.), and the like. Using the distribution, the algorithm may identify a number of times transactions were likely conducted for a particular type of group (e.g., 12 times over the last month transactions were conducted that likely included groups of 5 people or less). If the number of times exceeds a predetermined value (e.g., 10 times in the last month, 20 times overall, over 20% of the total number of transactions performed in that time range, etc.), the algorithm may set the data field to a particular value (e.g., good for small groups). It should be appreciated that the data management computer 190 may be configured to identify more than one group rating and may set more than one data field corresponding to those group ratings. Thus, the data management computer 190 could determine that the entity is “good for small groups” and “good for groups over 20.”

In some embodiments, an group rating(s) may be identified based at least in part on a machine learning model. The data management computer 190 may be configured to train and maintain (or access) a machine learning model that has been previously trained to identify one or more group ratings based on a set of transaction data provided as input. By way of example, the machine learning model may be trained using a training data set (e.g., historical transaction data) that includes various example transaction sets corresponding to individual resource provider for which one or more group ratings are known. Executing a supervised machine learning algorithm with the training data set may train the machine learning model (e.g., fit a mathematical model to the training data) such that new transaction data (e.g., this resource provider's last month of transaction data) may be provided to the model and the model may identify one or more new group ratings for the resource provider.

For at least one data field, a corresponding algorithm (e.g., as determined from the mapping) may utilize a particular set of transaction data (e.g., transaction data from the last month, year, week, etc.) to determine a traffic during particular periods of times (e.g., each open hour of the day, of each day, etc.). The algorithm may be utilized determine a distribution of the transactions over particular periods of time (e.g., 10 transaction were conducted between 9 AM and 10 AM on Monday). In some embodiments, the algorithm may be utilized to first determine an average number of historical transactions over corresponding time periods (e.g., an average number of transactions occurring between 9 AM and 10 AM on Mondays over the last year, an average number of transactions occurring between 10 AM and 11 AM on Mondays over the last year, etc.). In some embodiments, the average number of transactions for each corresponding time period may be used to generate the distribution. Data defining the distribution may be generated by the data management computer 190 and may be stored. In some embodiments, the data management computer 190 may be configured to identify a “best time to visit” data field based at least in part on the distribution (e.g., based at least in part on identifying a day and/or time period having a lowest actual or average number of transactions historically, as determined from the distribution).

For at least one data field, a corresponding algorithm (e.g., as determined from the mapping) may utilize a particular set of transaction data (e.g., transaction data associated with one or more second entities (e.g., other users) to determine, generate, or infer at least one data field element (e.g., a loyalty score, etc.). By way of example, the data management computer 190 may compute a number of times a second entity (e.g., another user different from the user 106 of FIG. 1) performed a transaction including the resource provider over a given time period (e.g., the last week, the last month, the last year, etc.). The data management computer 190 may perform this calculation for any suitable number of entities (e.g., second entities such as other users). In this manner, the data management computer 190 may determine whether and/or how often entities return to the same resource provider. In some embodiments, the data management computer 190 may be configured to calculate a loyalty score based at least in part on determining a number of times (corresponding to various entities such as other users) that the entities visited the resource provider's establishment. In some embodiments, the data management computer 190 may be configured to calculate a data field element (e.g., a loyalty score, etc.) based at least in part on determining how many times users conducted a number of transactions where the number exceeded a predefined threshold value (e.g., 3, 5, 10) in a given time period (e.g., the last week, the last month, the last year, etc.).

For at least one data field, a corresponding algorithm (e.g., as determined from the mapping) may utilize a machine-learning model trained to identify popularity scores for resource providers. The data management computer 190 may be configured to train and maintain (or access) a machine learning model that has been previously trained to identify one or more popularity scores based on a set of transaction data provided as input. By way of example, the machine learning model may be trained using a training data set (e.g., historical transaction data) that includes various example transaction sets corresponding to individual resource provider for which one or more popularity scores are known. Executing a supervised machine learning algorithm with the training data set may train the machine learning model (e.g., fit a mathematical model to the training data) such that new transaction data (e.g., this resource provider's last month of transaction data) may be provided to the model as input and the model may identify one or more new popularity ratings for the resource provider. The popularity scores may vary based at least in part on a number of times a customer visits an establishment associated with the resource provider over a particular time period, although the popularity scores may additionally or alternatively vary on other factors. In some embodiments, a popularity score may be calculated based at least in part on determining that a number of transactions conducted with the resource provider exceeded a predetermined threshold value (e.g., if over 20 people transacted at a resource provider's restaurant, the restaurant can be assigned a particular popularity score). It may be the case, that the popularity score may be based at least in part on a time period over which the number of transactions were conducted (e.g., 20 people transacted today, in the last hour, over the last month, etc.).

It should be appreciated that any suitable data field of the incomplete profile may be identified using a machine learning model and/or a predetermined rule set. The data management computer 190 can generate and/or maintain any suitable number of machine learning models. If a machine learning model is used, the data management computer 190 may be configured to train and maintain (or access) any suitable number of machine learning models that has been previously trained to identify one or more data elements of a profile based at least in part on input data (e.g., transaction data associated with the resource provider, profile data associated with the resource provider, etc.). In some embodiments, the machine learning model may be trained using a training data set (e.g., historical transaction data) that includes various example transaction sets corresponding to individual resource provider for which one or more popularity scores are known. Executing a supervised machine learning algorithm with the training data set may train the machine learning model (e.g., fit a mathematical model to the training data) such that new transaction data (e.g., this resource provider's last month of transaction data) may be provided to the model and the model may identify one or more new group ratings for the resource provider. It should be appreciated that a labeled data set may not be needed in some embodiments. Rather, in some embodiments, the machine learning model may be trained using an unlabeled training data set (e.g., historical transaction data). For example, in some embodiments, the machine learning model may be generated using an unsupervised machine learning algorithm (e.g., a clustering algorithm) to identify when two resource providers appear to have similar characteristics and/or traits. If so, the data management computer 190 may be configured to infer characteristics and/or attributes (e.g., data field elements) of the resource provider from characteristics and/or attributes (e.g., data field elements) of the similar resource provider. In some embodiments, the historical transaction data of a particular resource provider may be provided to the machine learning model as input. The model may output indicating a particular characteristic (e.g., entity type) of the resource provider. In some embodiments, determining the

Returning to the method 200, once the one or more data field elements are generated, determined, and/or inferred at 214, they may be used to populate at least one data field of the incomplete profile. The updated profile may be stored (e.g., in the object/container). In some embodiments, the profile may be considered complete based at least in part on the addition of the one or more data fields determined by the data management computer 190. Alternatively, the profile may continue to be considered incomplete even after the addition of the one or more data fields. It should be appreciated that in either case, the operations performed at 206-214 may be repeated any suitable number of times, according to a schedule or predetermined frequency, upon demand, or at any suitable time. In some embodiments the operations 206-214 may be repeated until the profile can be considered complete (e.g., a particular set of data elements for the data fields of the profile have been determined, all data fields have been assigned a data element (e.g., a value), etc.).

At 216, the data management computer 190 may be configured to return any data elements (e.g., values corresponding to the previously missing/empty data fields) that have been generated/derived/inferred at 214 to the review platform computer 170. This data may be communicated in a data response transmitted in response to the data request received at 204. The data request and data response may be messages of any suitable format.

At 218, the review platform computer 170 may be configured to present the received data element(s) via one or more interfaces of the review platform 192. It should be appreciated that, in some embodiments, the review platform computer 170 may provide (e.g., via the resource provider device 180) an option for the resource provider 112 to confirm the data elements before presenting them via the one or more interfaces of the review platform 192. In some embodiments, if the data field element(s) are confirmed, the review platform computer 170 can store and present the data field elements via one or more interfaces of the review platform 192. In some embodiments, the review platform computer 170 may transmit a confirmation indication indicating the accuracy of at least one data field has been confirmed back to the data management computer 190 (not depicted). In this scenario, the data management computer 190 may be configured to store the confirmed data field element determined at 214 only upon receiving a confirmation indication indicating the data field element is accurate. In some embodiments, the data management computer 190 may update a training data set for a machine-learning model (e.g., add transaction data and the one or more data field elements) only upon receiving the confirmation indication indicating that the data field element(s) are accurate If the resource provider 112 instead indicates the data elements are incorrect, the data elements may be discarded and not presented at the review platform 192.

It should be appreciated that the review platform computer 170 may be configured to aggregate and present any suitable portion of the transaction data and/or the profile data stored within the review platform 192. By way of example, the review platform computer 170 may be configured to present, at an interface associated with a resource provider, aggregated transaction data. For example, the review platform computer 170 could analyze the transaction data to determine that users between the ages of 18 and 35 spend, on average, a particular amount at the resource provider while users over the age of 35 spend a different amount, on average, per transaction. In fact, any particular data field and/or data element (e.g., value of the data field) can be determined (e.g., by the data management computer 190) based at least in part on a subset of transaction data (e.g., transaction data involving a person between the ages of 18-25, persons living in a particular zip code, females, and the like) such that any data field may have multiple corresponding data elements determined. By way of example, a popularity score for teenagers, a popularity score for 25-35 year olds, a popularity score for women/men, etc.

Although not depicted, in some embodiments, the data management computer 190 may be configured to periodically retrain and/or incrementally update one or more machine learning models. The data management computer 190 may do so independent of user interaction (e.g., automatically, without previously receiving a request of other indication that such operations are requested). In some embodiments, the data management computer 190 may be configured to add input data (e.g., transaction data) and output data (e.g., a corresponding data element of a data field) to training data with which a model (or models) are to be retrained. It may be the case that the data management computer 190 may be configured to add input/output data only after a user (e.g., the resource provider 112) has indicated that the output data is accurate. Thus, if the user (e.g., the resource provider 112) indicates the value(s) determined by the data management computer 190 are accurate, this indication can be received at the review platform computer 170 and forwarded to the data management computer 190 to invoke a subsequent retraining or incremental update of one or more machine learning models maintained by the data management computer 190.

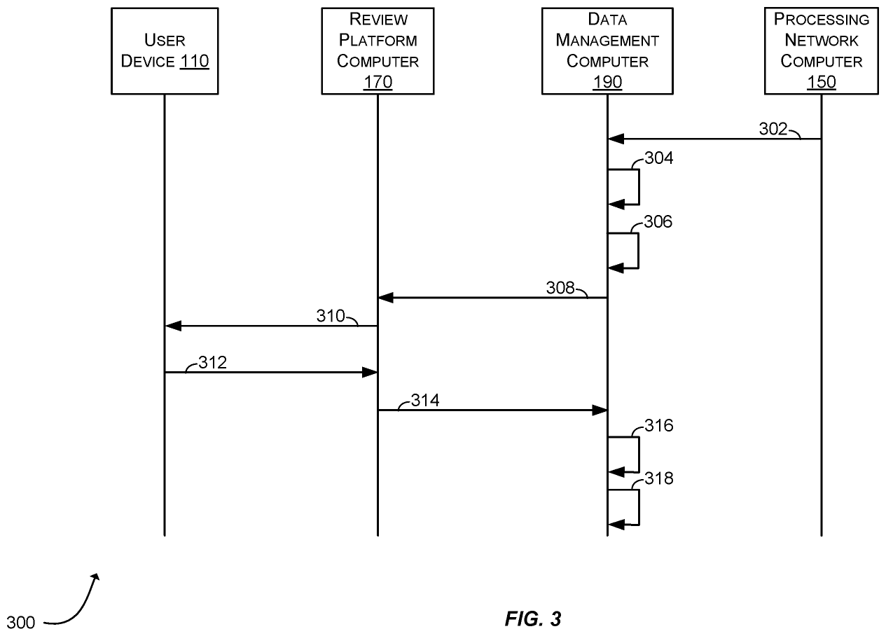

FIG. 3 shows a flow of another example method 300 for generating suggested data from transaction data, according to some embodiments. It should be appreciated that the operations of the method 300 may be performed in any suitable, not necessarily the order depicted in FIG. 3. Further, the method 300 may include additional, or fewer operations than those depicted in FIG. 3. The operations of method 300 may be performed any suitable combination of one or more devices of FIG. 1.

The method 300 may begin at 302, where the processing network computer 150 may transmit any suitable amount of transaction data to the data management computer 190. In some embodiments, the transaction data may be transmitted in response to the data management computer 190 performing a registration process (not depicted) with the user device 110 of FIG. 1. Prior to execution of the operations at 302, the user device 110 may be utilized by the user 106 of FIG. 1 to register via the review platform 192 of FIG. 1. This registration process may be performed using one or more user interfaces provided by the review platform computer 170. Upon completion of this registration process, the review platform computer 170 may assign a unique identifier for the user 106. In some embodiments, the user 106 may provide a unique identifier (e.g., a debit card number, an account number, a credit card number) by which the user 106 may be identified within the processing system 194. Thus, the review platform computer 170 may be configured to maintain a mapping between a unique identifier of the user used by the review platform 192 and a unique identifier of the user used within the processing system 194. The processing network computer 150 may transmit the transaction data at 302 in response to receiving a request for such data from the data management computer 190 (not depicted), according to a predetermined schedule, according to a predetermined frequency, upon receipt of transaction data associated with the user 106, or at any suitable time. As a non-limiting example, upon completion of the registration process between the review platform computer 170 and the user device 110, the review platform computer 170 may transmit the unique identifier of the user 106 to the processing network computer 150 to request transaction data associated with the user 106. In some embodiments, the processing network computer 150 can transmit any suitable number of transaction data instances based on a single request and/or based on each request received from the data management computer 190. In some embodiments, the processing network computer 150 is configured to transmit all transaction data (e.g., associated with the user 106 and/or one or more other users) upon receipt, according to a schedule (e.g., at midnight each day), according to a predetermined frequency (e.g., daily, monthly, etc.), upon request, or at any suitable time.

In some embodiments, the data management computer 190 may identify (e.g., based at least in part on a predetermined rule set) that a predetermined condition has been met. By way of example, the data management computer 190 may be configured to identify that the user 106 has conducted over a threshold number of transactions (e.g., more than 1, over 5, etc.) with a particular resource provider. In some embodiments, this threshold may be time based such that the user 106 may be required to conduct a number of transactions over the threshold within a particular time period (e.g., over the last month, week, year, etc.).

At 306, the data management computer 190 may be configured to identify suggested data (e.g., one or more data elements/values for one or more data fields to be suggested to the user 106). By way of example, the data management computer 190 may be configured to identify a review rating for the resource provider 112 to be suggested to the user 106. In some embodiments, the data management computer 190 may calculate a review rating based at least in part on a predetermined formula. Some factors which may affect the review rating may include frequency of transactions, number of transactions, whether the frequency of the transactions has increased or decreased over time, one or more amounts associated with the transactions, an average transaction amount associated with transactions conducted with the resource provider 112 (e.g., by the user 106 or generally, by all users, by more than one user, etc.).

In some embodiments, the suggested data (e.g., a suggested review rating) may be determined/generated utilizing a machine-learning model trained to identify such data for resource providers based at least in part on transaction data of a given user (and/or of multiple users). For example, the data management computer 190 may be configured to train and maintain (or access) a machine learning model that has been previously trained to identify a suggested review score for a resource provider based on a set of transaction data (e.g., transactions conducted by the user with the resource provider). By way of example, the machine learning model may be trained using a training data set (e.g., historical transaction data) that includes various example transaction sets corresponding to the user (e.g., transactions conducted with this or other resource providers) or multiple users (e.g., transactions conducted by all users with this or other resource providers, transaction conducted by similar users with this or other resource providers). Each set of transaction data may be associated with a review rating. Thus, the training data set may include historical transaction data associated with other resource providers with which the user 106 has transacted may be stored, along with profile data associated with the user 106 (e.g., name, age, address, profession, etc.) and/or the resource providers, and review ratings assigned to those resource providers by the user 106 in the past. Similarly, the training data set may include one or more instances of historical transaction data, and/or profile data (e.g., name, age, address, profession, etc.) of one or both parties of the transaction, and/or corresponding review ratings. In some embodiments, executing a supervised machine learning algorithm with the training data set may train the machine learning model (e.g., fit a mathematical model to the training data) such that new transaction data (e.g., the transaction data associated with the user 106 and the resource provider 112) may be provided to the model and the model may identify a suggested review rating for the resource provider. By utilizing the training data set described above, the machine learning model can learn identify a review rating based on historical ratings provided by the user and/or based on rating provided by other users to the same or different resource providers.

At 308, the data management computer 190 may transmit the suggested data (e.g., the suggested review rating) to the review platform computer 170. Upon receipt, or at any suitable time, the review platform may electronically communicate the suggested data to the user via the user device 110. By way of example, the review platform computer 170 may transmit the suggested data (e.g., via email, via a push notification, via text messaging, etc.) to the user device 110 at 310. As another example, the review platform computer 170 may present the suggested data via an interface which is rendered at the user device 110. In some embodiments, presenting the suggested data may include providing an option for the user (e.g., the user 106) to confirm the accuracy of the suggested data and/or to approve/deny submission of the suggested data.

For example, the suggested data may include a review rating indicating the resource provider 112 was rated four out of five stars (or another suitable rating of the same or different rating scale). At 312, the user may select the option to confirm the accuracy and/or approve/deny the submission of the suggested data. By way of example, the user 106 could enter in text such as “this place was great!!” and select a user interface elements such as a button to submit the test and the review rating. Alternatively, the user 106 could modify the rating and/or decline the suggested data altogether. If modified, the modified rating may be sent to the review platform computer 170 at 312.

At 314, the review platform computer 170 can store the received review rating (and text if provided) and transmit the received review rating (and text if provided) to the data management computer 190. Storing the review rating may cause the review platform computer 170 to present the review rating via one or more interfaces of the review platform 192.

At 316, the data management computer 190 may be configured to check to see if the review rating received matches the suggested review rating determined at 306. If there is a match, the data management computer 190 may be configured to add the review rating and corresponding transaction data with which the review rating was determined to the training data set (if a machine learning model was used at 306). If the review rating was modified, the data management computer 190 may be configured to exclude the review rating and its corresponding transaction data from being added to the training data set (if a machine learning model was used at 306).

At 318, the data management computer 190 may be configured to retrain the machine learning model (if a machine learning model was utilized at 306). In some embodiments, the training data set utilized to retrain the machine learning model may include the review rating and transaction data used as input at 306.

It should be appreciated that method 300 may be utilized for determining and providing any suitable suggested data and/or any suitable data associated with the user 106. As another non-limiting example, the data management computer 190 may be configured to provide updated profile data for the user 106 to the review platform computer 180. For example, the data management computer 190 may determine a number of times the user 106 visited an establishment and/or location associated with the resource provider, the user's payment preference (e.g., what form of payment he used most often), an average amount spent per visit, or any suitable information. One transmitted to the review platform computer 170, the review platform computer 170 may be configured to present the data via any suitable user interface of the review platform 192.

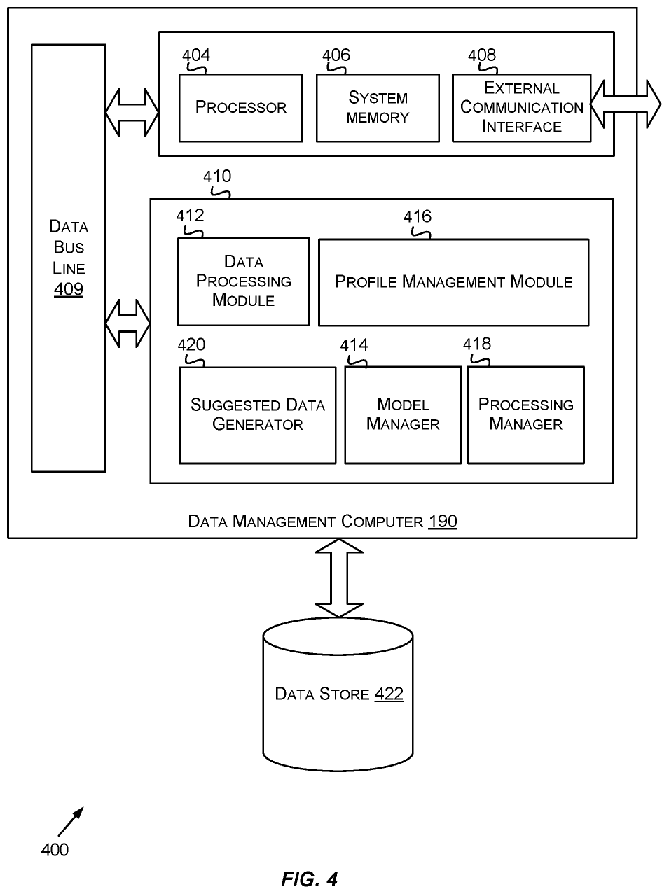

FIG. 4 illustrates a block diagram of an exemplary data management computer (e.g., the data management computer 190 of FIGS. 1-3), according to some embodiments. The data management computer 190 is illustrated as comprising a plurality of hardware and software modules (404-420). However, it should be appreciated that this is provided for illustration purposes only, and each of the modules and associated functionality may be provided and/or performed by the same or different components. That is, the data management computer 190 may perform some of the relevant functions and steps described herein with reference to the data management computer 190 through the use of any suitable combination of software instructions and/or hardware configurations. It should be noted that although FIG. 4 illustrates all of the modules located on a single device, the disclosure is not meant to be so limited. Moreover, a system for implementing the functionality of the data management computer 190 described herein may have additional components or less then all of these components. Additionally, some modules may be located on other devices such as a remote server or other local devices that are functionally connected to the server computer component(s). In some cases, the software modules may be located on a virtual machine or a container.

The data management computer 190 is shown as comprising a processor 404, system memory 406 (which may comprise any combination of volatile and/or non-volatile memory such as, for example, buffer memory, RAM, DRAM, ROM, flash, or any other suitable memory device), and an external communication interface 408. Moreover, one or more of the modules 410 (e.g., modules 412-420) may be disposed within one or more of the components of the system memory 406, or may be disposed externally. As was noted above, the software and hardware modules shown in FIG. 4 (and other systems described herein) are provided for illustration purposes only, and the configurations are not intended to be limiting. The processor 404, system memory 406 and/or external communication interface 408 may be used in conjunction with any of the modules described below to provide a desired functionality. Some exemplary modules and related functionality may be as follows:

A data processing module 412 may be configured or programmed to perform some or all of the functionality associated with receiving, sending, and generating electronic messages for transmission at the data management computer 190 to or from any of the entities shown in FIG. 4. When an electronic message is received by the data management computer 190 via the external communication interface 408, it may be passed to the data processing module 412. The data processing module 412 may identify and parse the relevant data based on a particular messaging protocol used in the data management computer 190. The data processing module 412 may then transmit any received information to an appropriate module within the data management computer 190 (e.g., via a data bus line 409). The data processing module 412 may also receive information from one or more of the modules in the data management computer 190 and generate an electronic message in an appropriate data format in conformance with a transmission protocol used in the data management computer 190 so that the message may be sent to one or more entities within system 100 (e.g., to the review platform computer 170 of FIG. 1). The electronic message may then be passed to the external communication interface 408 for transmission.

In some embodiments, the data processing module 412 may be configured to receive any suitable set of mappings and/or rules for generating data elements for missing data fields of profile data. In some embodiments, the mappings may identify, for a corresponding entity (e.g., a resource provider such as resource provider 112 of FIG. 1) and/or entity type (e.g., restaurant, doctor's office, coffee shop, clothing store, etc.), and a particular algorithm for generating a data field element (e.g., a value) for a particular data field. It should be appreciated that, in some embodiments, mappings may not be utilized. Instead, the profile management module 416 may be configured with code specific to each data field for generating values for that data field. In some embodiments, the data processing module 412 may receive one or more templates specifying particular data fields and/or data types and/or acceptable value for each data field of profile data associated with a particular entity and/or type of entity. A template may be an object and/or other suitable container. In some embodiments, the template may be referred to as a “schema” or “profile specification.” In some embodiments, the data processing module 412 may be configured to receive one or more training data sets (e.g., one or more sets of historical transaction data or other data to be utilized to train one or more machine learning models). The data processing module 412 may be configured to store any suitable combination of the mappings, rule sets, templates, and/or training data sets in the data store 422, a data store configured to store such information. It should be appreciated that the data store 422 may be local or remote with respect to the data management computer 190. That is, the data store 422 may reside within system memory 406 or the data store 422 (or some part of the data store 422) may reside at a location separate from the data management computer 190 but accessible to the data management computer 190. In some embodiments, any suitable combination of the modules 410 may be configured to access the data store 422 for any suitable purpose. In some embodiments, the data processing module 412 may be configured to provide any suitable number of application programming interfaces and/or any suitable number of user interfaces with which functionality of the module 410 may be invoked and/or with which data provided by the data management computer 190 may be transmitted.

In some embodiments, the data processing module 412 may be configured to receive and store any suitable amount of transaction data (e.g., from the processing network computer 150 of FIGS. 1-3). In some embodiments, the received transaction data may be stored in the data store 422 or another suitable storage location accessible to the data management computer 190.

In some embodiments, the data management computer 190 may include a model manager 414. The model manager 414 may be configured to generate and/or maintain any suitable number of machine learning models. In some embodiments, the model manager 414 may be configured to utilize any suitable combination of one or more training data sets retrieved from the data store 422 to train, retrain, or incrementally update one or more models. The model manager 414 may utilize any suitable supervised and/or unsupervised machine learning algorithms with the training data set(s) to train/generate the model. When trained, the model may be a mathematical function that has been fit to the training data set such that the model may be configured to identify new output data from new input data based at least in part on data it has learned from analyzing the training data set. The model manager 414 may be configured to train, retrain, update any suitable combination of one or more machine learning models according to any suitable schedule, according to any suitable frequency, on demand, or the like. The models maintained by the model manager 414 may be stored in the data store 422 for subsequent use.

In some embodiments, the data management computer 190 may include a profile management module 416. The profile management module 416 may be configured to utilize one or more machine models and/or one or more rule sets from the data store 422 to identify one or more data elements (e.g., values) of the data fields of a profile. In some embodiments, the data management computer 190 may be configured to receive a data request (e.g., from the data processing module 412). Using resource provider identifier of the data request, the profile management module 416 may retrieve a template, mapping, and/or rule set associated with the entity associated with the data request (e.g., the resource provider 112 of FIG. 1). The profile management module 416 may determine (e.g., by comparing the data fields of the data request to data fields of the template which specifies a complete set of data fields for a profile) a set of missing data fields of a profile. For example, using a template associated with the resource provider 112 (or resource providers of the type associated with the resource provider 112), the profile management module 416 may identify which data fields are missing from the resource provider's profile. Using either algorithms/rule sets identified in the mapping (or provided within the software of the profile management module 416) the profile management module 416 may generate one or more data elements for those missing data fields. In some embodiments, the profile management module 416 may be configured to utilize one or more machine learning model retrieved from the data store 422. FIG. 2 described some of the operations performable by the profile management module 416.

In some embodiments, the processing manager 418 may be configured to receive and store any schedule and/or rule for reassessing profile data. By way of example, an administrator may designate a schedule and/or rule by which the data management computer 190 may reanalyze a profile (e.g., an incomplete profile). The processing manager 418 may receive a schedule and/or rule (e.g., from the data processing module 412) and may store the schedule and/or rule within the data store 422. The processing manager 418 may then invoke the functionality provided by the profile management module 416 according to the schedule and/or rule.

In some embodiments, the data management computer 190 may include a suggested data generator 420. The suggested data generator 420 may be configured to identify a review rating for a resource provider (e.g., the resource provider 112) to be suggested to a user (e.g., the user 106 of FIG. 1). In some embodiments, the suggested data generator 420 may calculate a review rating based at least in part on a predetermined formula. Some factors which may affect the review rating may include frequency of transactions, number of transactions, whether the frequency of the transactions has increased or decreased over time, one or more amounts associated with the transactions, an average transaction amount associated with transactions conducted with the resource provider 112 (e.g., by the user 106 or generally, by all users, by more than one user, etc.).

In some embodiments, the suggested data generator 420 may generate the suggested data utilizing a machine-learning model trained to identify such data for resource providers based at least in part on transaction data of a given user (and/or of multiple users). For example, the suggested data generator 420 may be configured to train and maintain (or access) a machine learning model that has been previously trained to identify a suggested review score for a resource provider based on a set of transaction data (e.g., transactions conducted by the user with the resource provider). By way of example, the machine learning model may be trained using a training data set (e.g., historical transaction data) that includes various example transaction sets corresponding to the user (e.g., transactions conducted with this or other resource providers) or multiple users (e.g., transactions conducted by all users with this or other resource providers, transaction conducted by similar users with this or other resource providers). Each set of transaction data may be associated with a review rating. Thus, the training data set may include historical transaction data associated with other resource providers with which the user 106 has transacted may be stored, along with profile data associated with the user 106 (e.g., name, age, address, profession, etc.) and/or the resource providers, and review ratings assigned to those resource providers by the user 106 in the past. Similarly, the training data set may include one or more instances of historical transaction data, and/or profile data (e.g., name, age, address, profession, etc.) of one or both parties of the transaction, and/or corresponding review ratings. In some embodiments, executing a supervised machine learning algorithm with the training data set may train the machine learning model (e.g., fit a mathematical model to the training data) such that new transaction data (e.g., the transaction data associated with the user 106 and the resource provider 112) may be provided to the model and the model may identify a suggested review rating for the resource provider. By utilizing the training data set described above, the machine learning model can learn identify a review rating based on historical ratings provided by the user and/or based on rating provided by other users to the same or different resource providers.

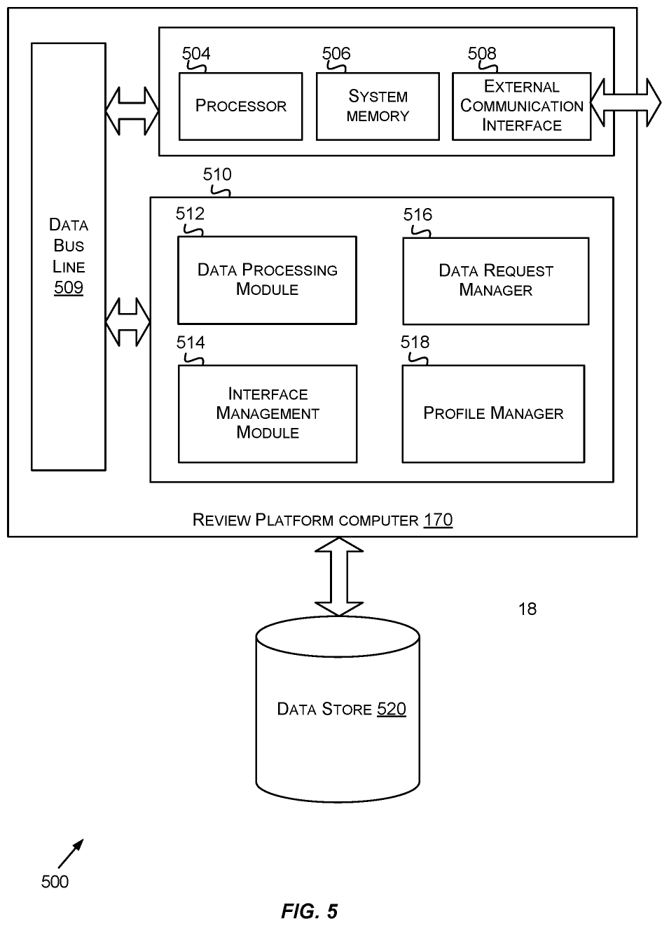

FIG. 5 illustrates a block diagram of an exemplary review platform computer (e.g., the review platform computer 170 of FIGS. 1-3), according to some embodiments. The review platform computer 170 is illustrated as comprising a plurality of hardware and software modules 510 (e.g., 512-518). However, it should be appreciated that this is provided for illustration purposes only, and each of the modules and associated functionality may be provided and/or performed by the same or different components. That is, the review platform computer 170 may perform some of the relevant functions and steps described herein with reference to the review platform computer 170 through the use of any suitable combination of software instructions and/or hardware configurations. It should be noted that although FIG. 5 illustrates all of the modules 510 being located on a single device, the disclosure is not meant to be so limited. Moreover, a system for implementing the functionality of the review platform computer 170 described herein may have additional components or less then all of these components. Additionally, some modules may be located on other devices such as a remote server or other local devices that are functionally connected to the server computer component(s). In some cases, the software modules may be located on a virtual machine or a container.

The review platform computer 170 is shown as comprising a processor 504, system memory 506 (which may comprise any combination of volatile and/or non-volatile memory such as, for example, buffer memory, RAM, DRAM, ROM, flash, or any other suitable memory device), and an external communication interface 408. Moreover, one or more of the modules 510 (e.g., modules 512-518) may be disposed within one or more of the components of the system memory 506, or may be disposed externally. As was noted above, the software and hardware modules shown in FIG. 5 (and other systems described herein) are provided for illustration purposes only, and the configurations are not intended to be limiting. The processor 504, system memory 506 and/or external communication interface 508 may be used in conjunction with any of the modules described below to provide a desired functionality. Some exemplary modules and related functionality may be as follows:

A data processing module 512 may be configured or programmed to perform some or all of the functionality associated with receiving, sending, and generating electronic messages for transmission at the review platform computer 170 to or from any of the entities shown in FIG. 5. When an electronic message is received by the review platform computer 170 via the external communication interface 508, it may be passed to the data processing module 512. The data processing module 512 may identify and parse the relevant data based on a particular messaging protocol used in the review platform computer 170. The data processing module 512 may then transmit any received information to an appropriate module within the review platform computer 170 (e.g., via a data bus line 509). The data processing module 512 may also receive information from one or more of the modules in the review platform computer 170 and generate an electronic message in an appropriate data format in conformance with a transmission protocol used in the review platform computer 170 so that the message may be sent to one or more entities within system 100 (e.g., to the data management computer 190 and/or the resource provider device 180 and/or the user device 110 of FIG. 1). The electronic message may then be passed to the external communication interface 508 for transmission.

In some embodiments, the review platform computer 170 may include an interface management module 514 configured to provide any suitable user interface discussed above in connection with FIGS. 1-4. User input provided via these user interfaces may be received by the interface management module 514 and transmitted to any suitable combination of the modules 510. In some embodiments, the data processing module 512 may receive data (e.g., suggested data from the data management computer 190) and may transmit this data to the interface management module 514 for presentation via one or more user interfaces. In some embodiments, the data processing module 512 may cause this data to be electronically conveyed (e.g., via email, text messaging, push notification, and the like) to a user device (e.g., the user device 110 of FIG. 1).

In some embodiments, the review platform computer 170 may include profile manager 518. Profile manager 518 may be configured to obtain profile data based at least in part on executing a registration process (e.g., with the user device 110 of FIG. 1). In some embodiments, the registration process may include receiving a set of data fields of a profile (e.g., a profile associated with the resource provider 112 of FIG. 1). The profile manager 518 may be configured to store the received profile data in data store 520 for subsequent use.

In some embodiments, the review platform computer 170 may include a data request manager 516. The data request manager 516 may be configured to transmit data requests for profile data (e.g., to the data management computer 190). In some embodiments, the data request manager 516 may be configured to determine that one or more data fields of a profile (e.g., a profile associated with the resource provider 112) is missing and/or empty. The data request may be transmitted in response to this determination. In some embodiments, the data request manager 516 may be configured to receive data responses including one or more data elements (e.g., values) determined by the data management computer 190. Any profile data received may be stored by the data request manager within data store 520 (e.g., within a profile/record associated with the resource provider 112).

### TECHNICAL ADVANTAGES

Embodiments of the invention have a number of advantages. For example, utilizing the techniques discussed above, profile data of one or more entities (e.g., entities of a review platform) may be automatically updated such that the data is more likely to be accurate that if such techniques were not utilized. The users of the platforms discussed herein are alleviated from performing manual updates to profile data. Instead, the profile data may be derived by the system and updated to be presented within the one or more provided user interfaces. Thus, users of the system are more likely to see more accurate information without requiring an entity to update their profile data. As another example, the system and methods herein enable a user to suggested data such as a review rating based at least in part on their transaction data with a particular entity. Thus, the user's experience is improved as the input may be provided faster with fewer inputs required by the user.

Any of the computing devices described herein may be an example of a computer system that may be used to implement any of the entities or components described above. The subsystems of such a computer system may be are interconnected via a system bus. Additional subsystems include a printer, keyboard, storage device, and monitor, which is coupled to display adapter. Peripherals and input/output (I/O) devices, which couple to I/O controller, can be connected to the computer system by any number of means known in the art, such as a serial port. For example, I/O port or external interface can be used to connect the computer apparatus to a wide area network such as the Internet, a mouse input device, or a scanner. The interconnection via system bus may allow the central processor to communicate with each subsystem and to control the execution of instructions from system memory or the storage device, as well as the exchange of information between subsystems. The system memory and/or the storage device may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method comprising:
analyzing, by server computer, an incomplete profile for an entity associated with a review platform, the incomplete profile including a plurality of data fields, wherein at least one data field in the plurality of data fields is empty;
determining, by the server computer, at least one data element for the at least one data field using transaction data associated with at least one transaction; and
populating, by the server computer, the at least one data field, thereby completing or partially completing the incomplete profile.

2. The method of claim 1, wherein the incomplete profile is associated with a first resource provider identifier, and wherein the method further comprises:
determining, by the server computer, a second resource provider identifier associated with the first resource provider identifier; and
determining, by the server computer, a plurality of transaction messages associated with the second resource provider identifier, wherein determining the at least one data element includes inferring the at least one data element from the plurality of transaction messages.

3. The method of claim 2, wherein the at least one data element comprises a time period when a resource provider associated with the first and second resource provider identifiers is publicly operational.

4. The method of claim 2, where the at least one data element comprises an indication that a resource provider allows one or more types of user devices to initiate transactions.

5. The method of claim 2, further comprising:
calculating, by the server computer, an average amount from amounts corresponding to the plurality of transaction messages; and
determining, by the server computer, that the average amount exceeds a predefined threshold value, wherein determining the at least one data element include inferring the at least one data element based at least in part on determining that the average amount exceeds the predefined threshold value.

6. The method of claim 2, wherein determining the at least one data element includes inferring a group rating based at least in part on computing, by the server computer, a number associated with a subset of the plurality of transaction messages that included a transaction amount that exceeded a predefined threshold value.

7. The method of claim 2, wherein determining the at least one data element includes inferring the at least one data element based at least in part on:
determining, by the server computer, a subset of transaction messages from the plurality of transaction messages, the subset of transaction messages corresponding to transaction performed between the resource provider and a second entity; and
computing, by the server computer, a number of the subset of transaction messages, wherein determining the at least one data element includes inferring the at least one data element based at least in part on determining the number exceeds a predefined threshold value.

8. The method of claim 1, further comprising receiving, by the server computer, the incomplete profile from a computing device associated with the review platform, the incomplete profile being received based at least in part on execution of a registration process between the entity and the review platform.

9. The method of claim 1, further comprising periodically receiving, by the server computer from a computing device associated with the review platform, a data request for data associated with the entity, wherein the incomplete profile is analyzed in response to receiving the data request.

10. The method of claim 1, further comprising providing, by the server computer, the at least one data field to a computing device associated with the review platform, whereby providing the at least one data field to the computing device causes the computing device to present the at least one data field at a user interface provided by the review platform.

11. A data management computer, comprising:
one or more processors; and
one or more memories storing computer-executable instructions that, when executed by the one or more processors, cause the data management computer to:
analyze an incomplete profile for an entity associated with a review platform, the incomplete profile including a plurality of data fields, wherein at least one data field in the plurality of data fields is empty;
determine at least one data element for the at least one data field using transaction data associated with at least one transaction; and
populate the at least one data field, thereby completing or partially completing the incomplete profile.

12. The data management computer of claim 11, wherein executing the computer-executable instructions further causes the data management computer to maintain a mapping between the data fields corresponding to a particular review platform and a predetermined set of algorithms for calculating values for those data fields.

13. The data management computer of claim 11, wherein executing the computer-executable instructions further causes the data management computer to:
maintain a machine-learning model trained to identify popularity scores for resource providers, the machine-learning model having been previously trained with at least one supervised learning technique and historical transaction data associated with popular and unpopular resource providers;
provide the transaction data to the machine-learning model as input; and
receive, from the machine-learning model, output indicating a popularity score for the resource provider, wherein determining the at least one data element includes inferring the at least one data element based at least in part on the popularity score for the resource provider.

14. The data management computer of claim 11, wherein executing the computer-executable instructions further causes the server computer to:
maintain a machine-learning model trained to identify one or more characteristics of resource providers, the machine-learning model having been previously trained with at least one supervised learning technique and historical transaction data associated with resource providers having a combination of the one or more characteristics;
provide the transaction data to the machine-learning model as input; and
receive, from the machine-learning model, output indicating a particular characteristic for the resource provider, wherein determining the at least one data element includes inferring the at least one data element based at least in part on receiving the output from the machine-learning model indicating the particular characteristic.

15. The data management computer of claim 14, wherein executing the computer-executable instructions further causes the data management computer to:
provide the at least one data field to the review platform, the review platform providing the at least one data field via a user interface in response to receiving the at least one data field; and
receive, from the review platform, a confirmation indication indicating an accuracy of the at least one data field has been confirmed; and
update a training data set for the machine-learning model based at least in part on the confirmation indication.

16. The data management computer of claim 15, wherein executing the computer-executable instructions further causes the data management computer to retrain or update the machine-learning model based at least in part on the training data set as updated.

17. The data management computer of claim 11, wherein executing the computer-executable instructions further causes the data management computer to:
perform a registration process with the review platform, wherein at least part of the registration process includes identifying a mapping between a first set of data fields of the entity and at least one of: i) a set of algorithms used to compute corresponding data element values, or ii) a second set of data fields utilized by the data management computer.

18. The data management computer of claim 17, wherein executing the computer-executable instructions further causes the data management computer to maintain a plurality of mappings for a plurality of entities comprising the entity.

19. The data management computer of claim 11, wherein the incomplete profile comprises a resource provider identifier, the transaction data being retrievable based at least in part on the resource provider identifier.

20. The data management computer of claim 11, wherein the at least one data element corresponds to a characteristic of the entity.
